(19) United States
(12) Patent Application Publication
(10) Pub. No.: US 2015/0149220 A1
(43) Pub. Date: May 28, 2015

(54) Methods and Procedures for a Travel Assistance Platform

(71) Applicant: Verizon Patent and Licensing Inc., Basking Ridge, NJ (US)

(72) Inventor: Hassan OMAR, Mt. Vernon, NY (US)

(73) Assignee: Verizon Patent and Licensing Inc., Basking Ridge, NJ (US)

(21) Appl. No.: 14/090,973

(22) Filed: Nov. 26, 2013

(51) Int. Cl. G06Q 10/02; G06Q 30/00

(52) U.S. Cl. CPC G06Q 10/02; G06Q 30/016
USPC 705/5

(57) ABSTRACT

A system and method for providing travel assistance and travel event processing. Travel events may include, for example, a cancellation associated with a travel reservation, a delay associated with a travel reservation, a timing change associated with a travel reservation, a travel reservation transaction, an environmental change potentially affecting travel, a location tracking event, and a service offer. By way of example, a travel reservation may include a reservation for an airline, railway, bus company, watercraft company, hotel or other-types of room accommodations, business events, such as, for example, a seminar, a conference, and/or a dining reservation, and/or recreational events, such as, for example, a tour, a concert, a show, a sporting event, an exploration outing, dining reservations, and/or other type of reserved recreational event.

### BACKGROUND INFORMATION

Modern travel may include various segments and travel arrangements, which may include multiple travel and service providers and/or multiple travel methods (e.g., car, train, bus, airplane, lodging, dining, etc.). Accordingly, coordinating any travel interruptions between service providers is becoming increasingly important in order to save on travel costs and time, while maintaining convenience. Such coordination may require sharing information such as, for example, traveler information, travel progress, current events, and any other data relevant to coordinate travel between service providers. However, such coordination should be accurate and efficient to provide proper service for the dynamic environment of travel planning. These and other drawbacks exist.

### BRIEF DESCRIPTION OF THE DRAWINGS

The present invention, together with further objects and advantages, may best be understood by reference to the following description taken in conjunction with the accompanying drawings, in the several figures of which like reference numerals identify like elements, and in which:

FIG. 1 is a schematic diagram illustrating a travel assistance system according to a particular embodiment;

FIG. 2 is a block diagram of hardware components of a travel assistance system according to a particular embodiment;

FIG. 3A is a flowchart illustrating travel assistance system operation according to a particular embodiment; and

FIG. 3B is a flowchart illustrating travel assistance system operation according to a particular embodiment;

FIG. 4 is a flowchart illustrating event processing by the travel assistance system according to a particular embodiment;

FIG. 5 is a flowchart illustrating cancellation event processing by the travel assistance system according to a particular embodiment;

FIG. 6 is a flowchart illustrating delay event processing by the travel assistance system according to a particular embodiment;

FIG. 7 is a flowchart illustrating timing change event processing by the travel assistance system according to a particular embodiment;

FIG. 8 is a flowchart illustrating reservation transaction event processing by the travel assistance system according to a particular embodiment;

FIG. 9 is a flowchart illustrating environment event processing by the travel assistance system according to a particular embodiment;

FIG. 10 is a flowchart illustrating location tracking event processing by the travel assistance system according to a particular embodiment;

FIG. 11 is a flowchart illustrating travel service offer event processing by the travel assistance system according to a particular embodiment.

### DETAILED DESCRIPTION OF PREFERRED EMBODIMENTS

A system and method may include various exemplary embodiments for providing travel assistance and travel event processing. Travel events may include, for example, a cancellation associated with a reservation, a delay associated with a reservation, a timing change associated with a reservation, a reservation transaction, an environmental change potentially affecting travel, a location tracking event, and a travel service offer. By way of example, a reservation may include a reservation for an airline, railway, bus company, watercraft company, hotel or other-types of room accommodations, business events, such as, for example, a seminar, a conference, and/or a dining reservation, and/or recreational events, such as, for example, a tour, a concert, a show, a sporting event, an exploration outing, and/or other type of reserved recreational event.

When a travel event occurs that may impact reservations such that a traveler may need to make adjustments to the travel reservations, the travel assistance system (TAS) may compile travel event information, analyze the travel event information to identify any impact on reservations, identify available options to accommodate the travel event information, propose and implement changes in the reservations, and coordinate with corresponding service providers according to traveler preference. For example, unexpected events, such as travel delays, unexpected weather conditions, results-dependent sporting competitions may impact travel plans and require dynamic changes to a reservations. As another example, location information associated with a traveler can be used to alert the service provider in advance about the traveler arrival delay, and can be used by the TAS system to solicit an alternative reservation with potential incentives for both the traveler and the service provider.

In addition to changes to reservations, friends, family, and/or colleagues may need to be updated on travel status associated with a traveler. A traveler may provide preference information related to what parties receive notifications related to events associated with reservations. For example, a traveler may control notifications for each reservation, travel segment, an entire trip, reservations booked through a certain service provider, and/or reservations booked using a certain method of payment. Traveler preferences may also include preference information associated with what sources to consider and a corresponding weight when evaluating them impact on a travel plan. For example, a subscriber may include a preference to ignore traveler location tracking information as long as it does not reflect an impact on travel by more than a predefined threshold, such as 20 minutes. User preferences may also tailor the degree by which the system is allowed to automatically implement potential resolutions related to travel changes. For example, a traveler my permit the system to react to a flight cancellation by automatically cancelling an associated hotel reservation. As another example, a traveler may select that any proposed cancellation or changes to a reservation must be approved and authorized by the traveler before proceeding.

Each travel event may be received by the travel assistance system (TAS) for processing in various modules of the TAS. As used herein, the term “module” may be understood to refer to computer executable software, firmware, hardware, or various combinations thereof. For example, the term “module” may include reference to a processor and supporting data storage related to information processed by the module. It is noted that the modules are exemplary. The modules may be combined, integrated, separated, or duplicated to support various applications. Also, a function described herein as being performed at a particular module may be performed at one or more other modules and by one or more other devices instead of or in addition to the function performed at the particular module. Further, the modules may be implemented across multiple devices or other components local or remote to one another. The modules may be implemented in a centralized system, or as a distributed system for additional scalability. Additionally, the modules may be moved from one device and added to another device, or may be included in both devices.

Each module described herein may include data storage such as network accessible storage, local storage, remote storage, or a combination thereof. Data storage may utilize a redundant array of inexpensive disks (“RAID”), tape, disk, a storage area network (“SAN”), an internet small computer systems interface (“iSCSI”) SAN, a Fibre Channel SAN, a common Internet File System (“CIFS”), network attached storage (“NAS”), a network file system (“NFS”), or other computer accessible storage. In one or more embodiments, data storage may be a database, such as an Oracle database, a Microsoft SQL Server database, a DB2 database, a MySQL database, a Sybase database, an object oriented database, a hierarchical database, or other database. Data storage may utilize flat file structures for storage of data.

The TAS may interface with service providers, which may include travel service providers, event service providers, entertainment service providers, and/or other service providers, to handle and process status, reservation and notification related information. While various elements of the TAS may include travel service provider elements, such as interfaces and databases, these elements may be available for all service providers alike. The TAS may also interface with information providers, which may include event information providers, travel service providers, transportation information providers, weather information providers, and the like, to handle and process information related to events which may impact travel schedules, such as, for example, flight delays, airport/seaport/road closures, weather events, sporting events, and the like. The TAS may interface with location tracking systems to obtain data related to the location and mobility of a traveler. The TAS may further interface with a traveler to obtain preference and travel plan data. A mobile device may also include a GPS-enabled or GPS-supported device, a telematics device that supports performing telematics functions, such as collecting, processing, presenting, and transmitting vehicle telematics data and information, and/or any other device that supports providing information relating to a traveler location. Telematics data and information from a vehicle may include data acquired from, or derived from data from, various sensors disposed in a vehicle such as data corresponding to engine parameters, drivertrain parameters, braking parameters, performance parameters, and/or location parameters from a location determination circuit (e.g., a GPS receiver typically provides latitude and longitude coordinates, speed, heading, and elevation, among other information). Such devices may support a tracking location agent to communicate location information to the TAS system.

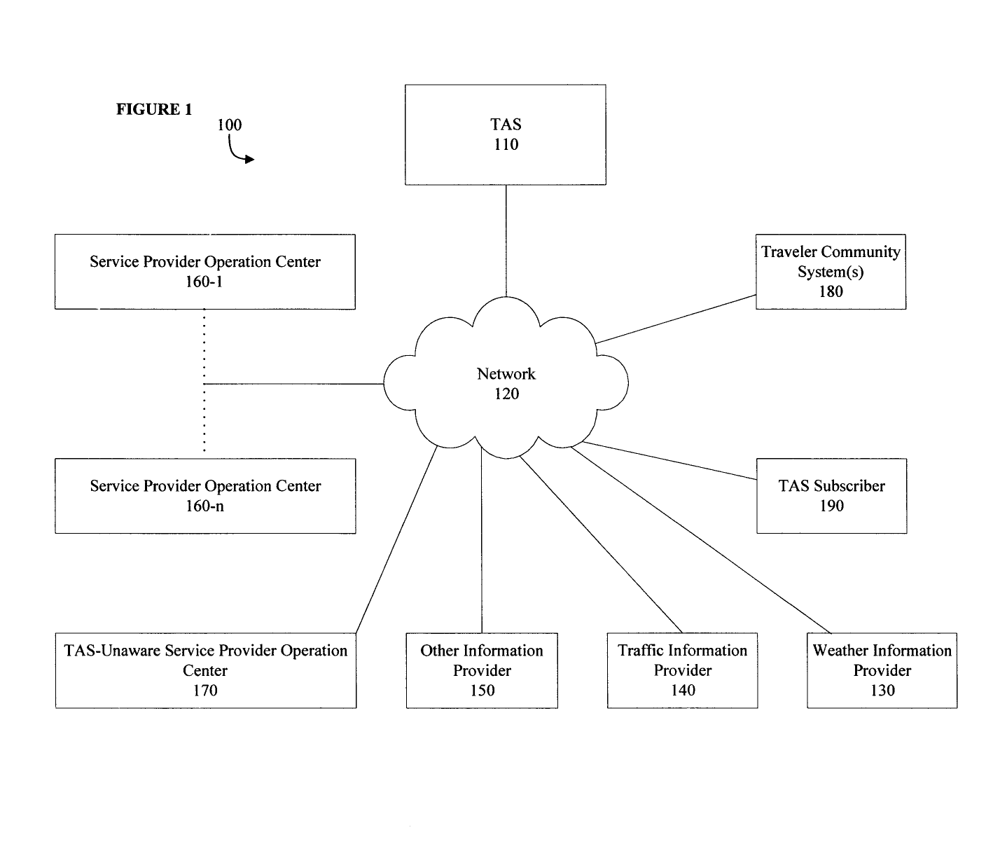

FIG. 1 is a schematic diagram illustrating a travel system 100 according to a particular embodiment. The travel system 100 may include at travel assistance system 110, which may interface with a variety of other systems to provide travel assistance when a travel event is received. The travel system 100 may also include a weather information provider 130, a traffic information provider 140, and other information providers 150, such as an international travel information provider, a waterway information provider, and the like. The travel system 100 may further include a TAS subscriber 190, which may be a traveler, and traveler community system(s) 180, which may include social networking systems such as Facebook, LinkedIn, Twitter, Google Plus, and the like. A TAS subscriber 190 may access TAS 110 using a variety of devices, such as a computer, a smartphone, a mobile device, a laptop, a personal digital assistant, a tablet, a phablet, a smart watch, or the like. Where the TAS subscriber 190 is a traveler, the TAS subscriber 190 may enable location tracking on a mobile device to provide location data to TAS 110.

The travel system 100 may include service provider operation center(s) 160-1 through 160-n and/or TAS-Unaware service provider operation center 170. A TAS-Unaware service provider operation center 170 may be a service provider who does not subscribe to the services of the TAS 110. The service provider operation center(s) 160 may each subscribe to the services of the TAS 110. For example a service provider 160 may include a travel service provider, a reservation service provider, and/or a transportation provider, such as, for example, a railway, which includes at least one transportation vehicle (e.g., a train) and an operation center to house current information associated with each transportation vehicle, such as, for example, service status, current schedules, and/or reservation data. Each of the components of the travel system 100 may be connected over a network 120. Other examples of transportation providers include, for example, airlines, limousine travel service, boating companies, bus companies, automobile rental companies, and the like.

Service provider operation center 160 may also include a discount booking travel service provider, which may include an operation center that acts as a centralized entity. The discount booking travel service provider may provide current information, such as, for example, service status, current schedules, and reservations, and interact with the TAS 110 through a TAS-Travel Service Provider Interface on the service provider side. An example of a service provider that is TAS-Unaware 170 may include service providers who do not have a TAS-Travel Service Provider Interface. In this example, the TAS-Unaware service provider may have limited access to TAS 110, such as, for example, transactions like email or other forms of electronic messaging.

Network 120 may be a wireless network, a wired network or any combination of wireless network and wired network. For example, network 120 may include one or more of a fiber optics network, a passive optical network, a cable network, an Internet network, a satellite network (e.g., operating in Band C, Band Ku or Band Ka), a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11n and 802.11g or any other wired or wireless network for transmitting and/or receiving a data signal. In addition, network 120 may include, without limitation, telephone line, fiber optics, IEEE Ethernet 802.3, a wide area network (“WAN”), a local area network (“LAN”), or a global network such as the Internet. Also, network 120 may support, an Internet network, a wireless communication network, a cellular network, or the like, or any combination thereof. Network 120 may further include one, or any number of the exemplary types of networks mentioned above operating as a stand-alone network or in cooperation with each other. Network 120 may utilize one or more protocols of one or more network elements to which it is communicatively coupled. Network 120 may translate to or from other protocols to one or more protocols of network devices. Although network 120 is depicted as one network, it should be appreciated that according to one or more embodiments, network 120 may comprise a plurality of interconnected networks, such as, for example, a service provider network, the Internet, a broadcaster's network, a cable television network, corporate networks, and home networks.

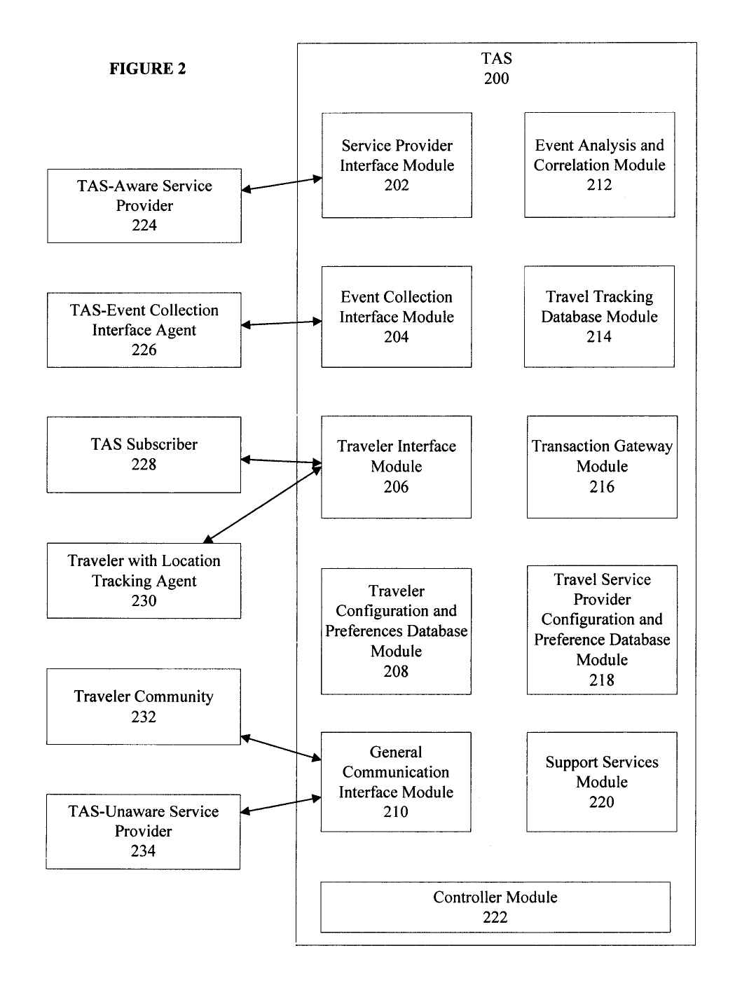

FIG. 2 is a block diagram of hardware components of TAS 200. TAS 200 may be a similar system to the TAS 110 as illustrated in FIG. 1. TAS 200 may include a variety of modules. The modules in TAS 200 may include TAS manage module that may run in a domain manager or be owned by a TAS service provider 224. TAS manager modules may be implemented as a number of software and/or hardware modules that may run on one or more computer systems(s). TAS manager modules may be combined on one computer system or distributed over a number of systems. Furthermore, one or more instance of each TAS manager module may exist. TAS manage modules may communicate with each other directly or indirectly and some TAS manager modules may communicate with external entities and/or modules, such as, for example, service providers 224, information providers (not pictured), the traveler 228, and a traveler community 232. TAS agent modules may be implemented in a number of software and/or hardware modules that may run on one or more computer system(s) to facilitate communication between an external entity and TAS manager modules. Different types of TAS agent modules may be used depending on the type of transaction carried over the interface. The modules in TAS 200 may also be TAS agents that may run in the domain of the service providers 224.

As illustrated in FIG. 2, TAS 200 may include a travel service provider interface (TSPI) module 202. TSPI module 202 may communicate with a TSPI agent on the travel service provider side to request and receive information such as status related trip progress that may be associated with a reservation. In this manner, the TSPI agent may be responsible for communication between the service provider 224 and the TSPI module 202 in the TAS provider domain. TSPI module 202 may also communicate with a TSPI agent to request and receive traveler reservations and/or traveler schedules. The TSPI module 202 may communicate with a TSPI agent using an agreed upon protocol and specifications, such as, for example, XML based transactions. The TSPI module 202 may also communicate with other TAS modules, such as the event analysis and correlation (EAC) module 212. In communicating with other TAS modules, the TSPI module 202 may provide information related to aspects of the travel progress (e.g., cancellations, delays, timing changes, location changes, and the like) and reservation information (e.g., seat availability, timing availability, service provider availability, and the like). Before providing information related to aspects of travel progress, the TSPI module 202 may filter information that may be identified as not relevant. In this manner, the TSPI module 202 may limit the amount of data sent to other TAS modules, such as the EAC module 212.

TAS 200 may also include an event collection interface (ECI) module 204. An ECI module 204 may receive and retrieve event information from various information providers via an event collection agent 226. In this manner, the event collection interface agent 226 may be responsible for the communication between the information provider and the ECI module in the TAS provider domain. Information received and retrieved by an ECI module 204 may include weather data, traffic data, road closure data, airport and seaport closure data, sporting event data, recreational reservation data, lodging data, and the like.

TAS 200 may include a traveler interface (TI) module 206. TI module 206 may communicate with travelers to support traveler profile and preference configuration, including user name, password, security settings, preferences regarding the handling of unexpected travel events, carrier preferences, seating preferences, lodging preferences, transportation mode preferences, timing preferences, and/or reservation preferences (e.g., automatically reserve next available same-airline flight following a cancellation, automatically reserve next available flight on any airline following a cancellation, provide traveler with a listing of available options and prompt traveler to selection option, automatically reserve the next flight equivalent in schedule and cost following a cancellation, and the like).

TI module 206, as an interface to the traveler, may also communicate with a tracking location agent 230 when supported and enabled by the traveler to extract traveler location data and transmit the data to an EAC module 212. In this manner, the tracking location agent 230 can enable communication between the traveler and the TAS 200 to provide location information and support tracking the progress of a travel plan for location identification. Location data may include telematics data that updates the location of a traveler and a predicted arrival time at a particular location. For example TI module 206 may receive data regarding a traveler location and current traffic conditions.

TAS 200 may also include a traveler configuration and preference database (TCPD) module 208. TCPD module 208 may include data storage and/or a processor to process and store configurations and preferences associated with TAS service subscribers, such as travelers.

TAS 200 may include a general communication interface (GC) module 210. GC module may communicate information to external entities, such as, for example, traveler community 232 and/or TAS-unaware service providers 234, as directed by the traveler configurations and preferences stored in a TCPD module 208. GC module 210 may also transmit notifications to one or more individuals upon detection of a preconfigured event. A preconfigured event may include deviation from a travel plan schedule, deviation from a travel plan according to a certain threshold, completion of a travel segment, upcoming travel segment, and the like. Notifications may include email, SMS, MMS, push notification, voicemail, and any other form of electronic communication. GC module 210 may also receive notifications from TAS-unaware service providers 234.

TAS 200 may further include an EAC module 212. An EAC module 212 may be responsible for receiving and processing information such as traveler location, travel related events, current travel schedule, and/or travel service availability. Traveler location data may be received from a traveler interface module 206. Travel related events may include cancellation event, delay events, timing change events, reservation transaction events, environment information events, location tracking events, and/or travel service events. A current travel schedule may be received from TSPI module 202, TI module 206, and/or GC module 210. Travel service availability data may be received from TSPI module 202, TCPD module 208, and/or GC module 210. By way of example EAC module 212 may receive travel related event data indicating, for example, a cancellation related to a receive travel schedule. EAC module 212 may then receive travel service availability data and compile a listing of available alternative options to either select for or send to a traveler for traveler selection.

TAS 200 may also include a travel tracking database (TTD) module 214. TTD module 214 may include data storage and/or a processor to process and store data related to traveler schedules and plans as well as corresponding updates and/or changes. TTD module 214 may receive data from TSPI module 202, TI module 206, GC module 210, and/or EAC module 212. TAS 200 may further include a transaction gateway (TG) module 216. TG module 216 may be responsible for handling transactions, such as reservations and/or cancellations. Reservations and/or cancellations may be received from TSPI module 202, TI module 206, and/or GC module 210. Moreover, TG module 216 may ensure that transactions comply with subscriber configuration and preference data received from TCPD module 208 and/or TSPCPD module 218.

TAS 200 may include a travel service provider configuration and preference database (TSPCPD) module 218. TSPCPD module 218 may include data storage and/or a processor to process and store data related to configuration and preference parameters associated with the various service providers. Configuration and preference parameters associated with a service provider may be received during the service creation from the TSPI module 202 and/or TI module 206. By way of example, data received, processed, and stored using the TSPCPD module 218 may include an IP address and a back-up IP address associated with the TSPI agent for a service provider, a maximum transaction rate, and the like.

TAS 200 may also include a support services (SS) module 220. SS module 220 may provide support for services like browsing, email, and other forms of electronic communication. SS module 220 may be utilized by other modules, such as, for example, GC module 210 to provide support for external communications. TAS 200 may also contain a controller module 222 to control communications and processing between the modules of TAS 200.

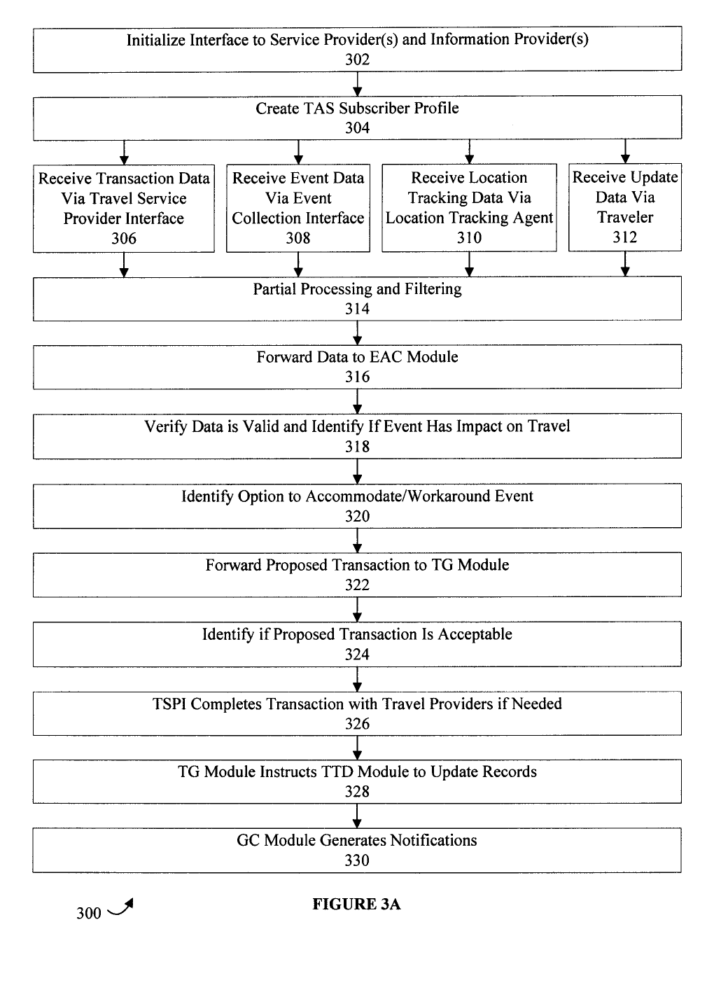

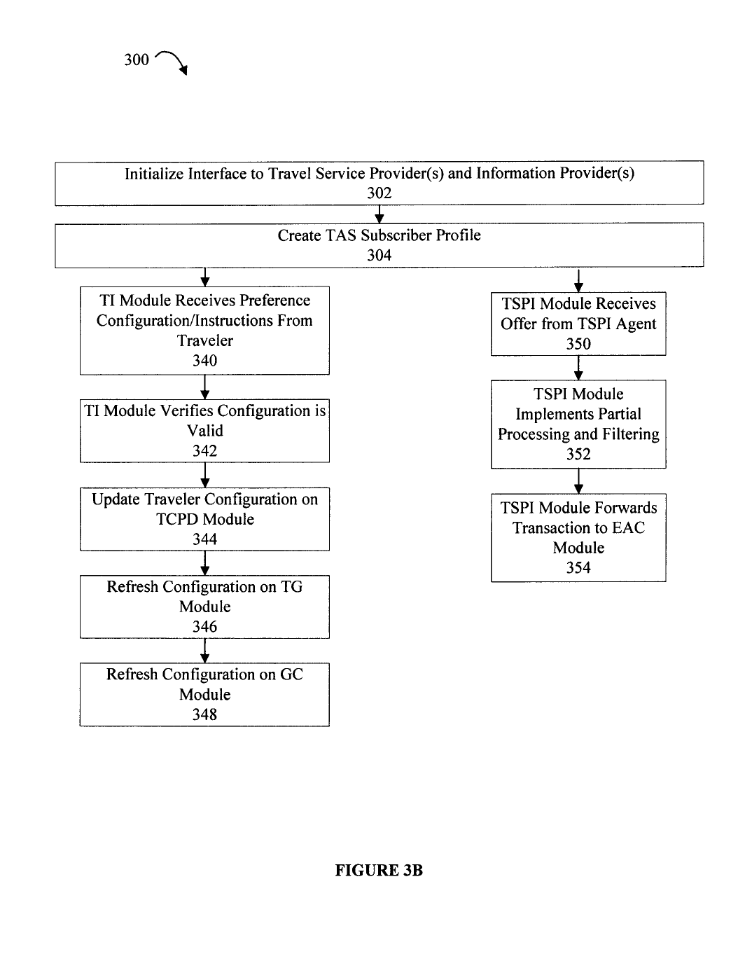

FIGS. 3A and 3B illustrate the TAS in operation 300 according to particular embodiments. TAS as described in FIGS. 3A and 3B may be similar to TAS 200 described in FIG. 2 and TAS 110 described in FIG. 1. Moreover where modules are referenced in FIGS. 3A and 3B, these modules may be similar to the corresponding modules illustrated in FIG. 2.

As illustrated in FIGS. 3A and 3B, TAS may identify service providers that may be willing to interact with services provided by TAS. Accordingly TAS may provide an initializing interface to service providers and information providers (step 302). Moreover, when a travel provider already in communication with TAS desires to update and/or change its services, the travel provider may provide the updates and/or changes using the initializing interface. Service providers that perform the initialization process (step 302) may communicate with TAS, particularly with a TSPI module. Service providers that do not perform the initialization process may not have an interface to a TSPI module and therefore may be TAS-unaware service providers. The initialization process (step 302) may ensure that the specifications of the interface between a TSPI module and the TSPI agent are agreed upon between a TAS service provider and a TAS-aware service provider. For example, specifications may include addressing (e.g., the address(es) used to communicate with a particular TSPI agent and/or TAS-aware service provider), the protocol and port number used for communication, security mechanism to protect the communications, and types of transactions that may be exchanged to support services offered by a TAS.

Data included in types of transactions specifications may include the format of requests for information, the format for responses to a request, transaction source, transaction destination, the nature of the services provided, and/or transaction fields. For example, transaction source and/or transaction destination may include TSPI agent or TSPI module. Nature of transaction may include, for example, tracking, service offers, environment, and/or reservation. Furthermore, transaction fields may include data regarding event notification, event notification response, query request, query response, reservation related request, reservation related response, reservation related notification, offer notification, TSPI maintenance request, TSPI maintenance response, and/or transaction details.

Step 302 may also include initialization of interfaces to information providers. TAS may identify information providers to communicate with TAS. The initialization process (step 302) may ensure that the specifications of the interface between ECI module and the ECI agent are agreed upon between a TAS service provider and an information provider. For example, specifications may include addressing (e.g., the address(es) used to communicate with a particular ECI agent and/or information provider), the protocol and port number used for communication, security mechanism to protect the communications, and types of transactions that may be exchanged to support services offered by a TAS.

Data included in types of transactions specifications may include the format of requests for information, the format for responses to a request, transaction source, transaction destination, transaction type, and/or transaction fields. For example, transaction source and/or transaction destination may include ECI agent or ECI module. Nature of transaction may include, for example, tracking, service offers, environment, and/or reservation. Furthermore, transaction fields may include data regarding event notification, event notification response, query request, query response, ECI maintenance request, ECI maintenance response, and/or transaction details.

Once specifications of the interfaces between the service providers and information providers are established, individuals may subscribe to TAS (step 304). A subscriber may create a TAS profile by access a TI module to interface with TAS. A subscriber may also communicate with a TI module to update a subscriber profile. A subscriber profile may include, for example, a user name and password, previously used service providers, service providers not used but intended to be used in the future, individuals and/or a group of individuals as a subscriber community, subscriber community communication method, a communication device capable of support a TAS-traveler location tracking agent, whether traveler location tracking is enabled, a desired TAS subscriber email account, account ID, and subscriber preferences. Subscriber preferences may include, for example, preferred service provider, preferred mode of transportation, preferred time of travel, lodging preferences, meal preferences, smoking/non-smoking preferences, preferences regarding the handling of unexpected travel events, seating preferences, and/or reservation preferences (e.g., automatically reserve next available service with the same service provider following a cancellation, automatically reserve next available service with any service provider following a cancellation, provide traveler with a listing of available options and prompt traveler to selection option, automatically reserve the next service equivalent in schedule and cost following a cancellation, automatically rebook to a different service provider when a delay reaches a preferred threshold, and the like).

Upon creation of a TAS subscriber profile (step 304) a subscriber may utilize TAS to receive travel assistance. A subscriber traveler may reserve one or more services from one or more service providers, including, for example, an event service provider. For example a subscriber traveler may reserve a mode of transportation, lodging, and a travel experience (e.g., conference, seminar, tour, show, concert, sporting event, dining event, and the like) for a travel plan. As used herein, “travel reservation” may be used to refer to any reservation a traveler may make associated with scheduled travel. If the traveler is a TAS subscriber and the service provider is TAS-aware, the service provider may allow the traveler to provide TAS identifying information. The service provider may then utilize a TSPI agent to transmit transaction data, including any reservations, to TAS through a TSPI module (step 306).

Additionally, once a subscriber has set up a profile and provided transaction and/or reservation information, TAS may associate received event data via ECI module (step 308) with impacted travel plans. Event data may include cancellation data, delay data, timing change data, service offer data, and/or environment data. Moreover, once a subscriber has set up a profile and provided transaction and/or reservation information, TAS may also receive location tracking data via a location tracking agent (step 310). Location tracking data may be received if a subscriber has provided information relating to a device capable of providing location tracking and the subscriber has enabled location tracking. For example, location tracking data may include GPS data, telematics data, and the like. In addition, TAS may receive update data via the TI module (step 312).

If the traveler is a TAS subscriber, but the service provider is TAS-unaware, the TAS subscriber can instruct the service provider to send an email or other form of electronic communication to the subscriber TAS account (e.g., via the TAS email account). The TAS-unaware communication may be intercepted by the GC module for partial processing and filtering (step 314), and depending on TAS subscriber preference stored in a TCPD module, the contents of the message may be directed to a queue on the TCPD module for subsequent manual inclusion in a travel plan by the subscriber, or forwarded to the EAC module for further processing. In other embodiments, a TAS subscriber may manually input reservation data into TAS using a TI module.

In addition, TAS modules, such as TSPI and ECI modules, for example, may receive information regarding the type of information and events needed at an EAC module so that not all information received at a TSPI module or ECI module is forwarded to the EAC module. According, all information received that is to be forwarded to the EAC module should be filtered and processed (step 314) so that only the necessary information is passed to the EAC module.

By way of example, in step 314 the EAC module may scan its local database and the TTD module to identify travel services and travel-service related event classes of relevance. The EAC module may then inform, for example, the TSPI module about the desired relevant information and the TSPI module may provide only that information. For example, EAC module may identify an interest in receiving information regarding the status of flights associated with Airline A (a service provider) arriving to NY, NJ, and MD airports. Accordingly, the TSPI module may only forward information related to flights arriving in NY, NJ, and MD for Airline A to the EAC module. To further enhance system performance a TAS-aware service provider may agree to an implementation where the interface between the TSPI module and the TSPI agent may support the TSPI module providing filter rules to the TSPI agent that specifies information needed. This may limit the exchange of irrelevant information.

As another example of step 314, the EAC module may scan its local data base and a TTD module to identify relevant event class(es). The EAC module may then inform the ECI module about the relevant information and the ECI module may provide only that relevant information to the EAC module. By way of example, the EAC module may identify that it is interested in receiving information regarding traffic conditions for routes from New York City Penn Station to JFK International Airport. Accordingly, the ECI module may only forward data relevant to this route. To further enhance system performance, an information provider may agree to an interface between the ECI module and the ECI agent that may support a capability for the ECI module to provide filter rules to the agent specifying the relevant information needed. This may limit the exchange of irrelevant information.

Furthermore, in step 314, transaction entered by a traveler through the TI module may automatically be determined to be relevant and passed to the EAC as long as they contain the necessary data. For mobility events generated by the traveler location tack agent and received by the TI module, the EAC module may identify a filter to receive updates only if a traveler location is expected to indicate an impact on the traveler travel plan. While the TI module may not have all necessary information to identify whether traveler travel plans will be impacted, EAC may instruct TI module not to forward location tracking information unless mobility events trigger a specific rule. For example, where a traveler is scheduled to be in a meeting at a Location A from 2:00 p.m. to 4:00 p.m. EAC module may instruct TI module to only forward location tracking information when the difference in traveler location between T1 and T1 plus 5 minutes is larger than 5 miles, where T1 is later than 2:00 p.m. and earlier than 4:00 p.m. To further enhance system performance, an information provider may agree to an interface between the TI module and the TI agent that may support a capability for the TI module to provide filter rules to the TI agent specifying the relevant information needed. This may limit the exchange of irrelevant information.

Once reservation/transaction/event/location/update data is received by TAS, and communicated to the TSPI module, the GC module, or TI module, the data may be forwarded to the EAC module (step 316) for further processing. Reservation/transaction/event/location/update data may be received by the EAC module and placed in a queue for processing. EAC module may then inspect the data to verify that the data contains required components for further processing (step 318). For example, EAC module may verify that the data identifies the TAS subscriber, the service provider, the reservation/transaction/event/location/update type, the reservation/transaction/event/location/update details, and a TAS-reservation identifier. EAC module may also identify if the reservation/transaction/event/location/update has an impact on an existing travel schedule (step 318). For example, a reservation or transaction may not have an impact on existing travel if the reservation or transaction data does not contain the required information and cannot be processed and added as a travel plan for the subscriber. In other examples, event, location, and update data may have an impact on existing travel where the event location, or update data results in the cancellation, delay, or change of time for a particular segment of a travel plan.

In step 320, the EAC module may identify options to accommodate any impact on existing travel. For example, where a reservation or transaction impact is detected, EAC module may transmit a message to the subscriber to correct the problem or may determine an alternative reservation or transaction to replace the current reservation or transaction. In other examples, where event, location, or update data indicates an impact on existing travel, EAC module may determine alternatives that may result in less of an impact or no impact to the existing travel. If received data has a limited impact on existing travel plans, the data may be forwarded to the TTD module (step 328) to update the corresponding records. For example, a flight delay of five minutes may result in updating the arrival time for the corresponding segment, with no other impact on other travel plans. Where the received event data does not indicate an impact on existing travel plans, the event data base be stored in the EAC module for record keeping.

In step 322, the proposed transaction may be forwarded to the TG module for processing. The TG module may then determine whether the proposed options determined in step 320 comply with subscriber current configurations and preferences (step 324). In step 326, the TSPI module may complete any necessary transactions with travel providers to implement proposed transactions that comply with subscriber configurations and preferences. Alternatively, the TI module may request subscriber authorization before the TSPI module may complete any necessary transaction with travel providers.

In step 328, the TG module may then instruct the TTD module to update subscriber travel plans to reflect the implemented changes. In addition, when necessary, the GC module may generate notifications to external entities as determined by the traveler profile. For example, the GC module may generate notifications to the traveler community as indicated in the traveler profile.

Regarding the traveler profile, a subscriber may update his or her traveler profile via the TI module. The TI module may receive preference configurations and instructions from the traveler in step 340. The TI module may then verify that the preference configurations and instructions are valid in step 342. One the preference configurations and instructions are determined valid, the TI module may transfer the preference configurations and instructions to the TCPD module for storage in step 344. In step 346, TCPD module may generate a signal to the TG module to refresh travel configurations to ensure they comply with new preference configurations and instructions. Finally, in step 348, the TCPD module may generate a signal to the GC module to refresh preference configurations and instructions associated with communications to external entities to ensure that the proper communications are transmitted by the GC module.

TAS may also receive an unsolicited offer from a service provider via a TSPI agent. In this manner, the TSPI agent providing the offer may forward the offer to the TSPI module (step 350). In step 352, the TSPI module may implement partial processing and filtering. The processing and filtering of step 352 may be a processing and filtering to determine if the offer is relevant to any travel whose preference configurations indicate that the traveler is willing to accept unsolicited offers. If the offer is determined relevant, the TSPI module may forward the offer details to the EAC module where it may be processed and selected to be implemented in a travel plan associated with a traveler.

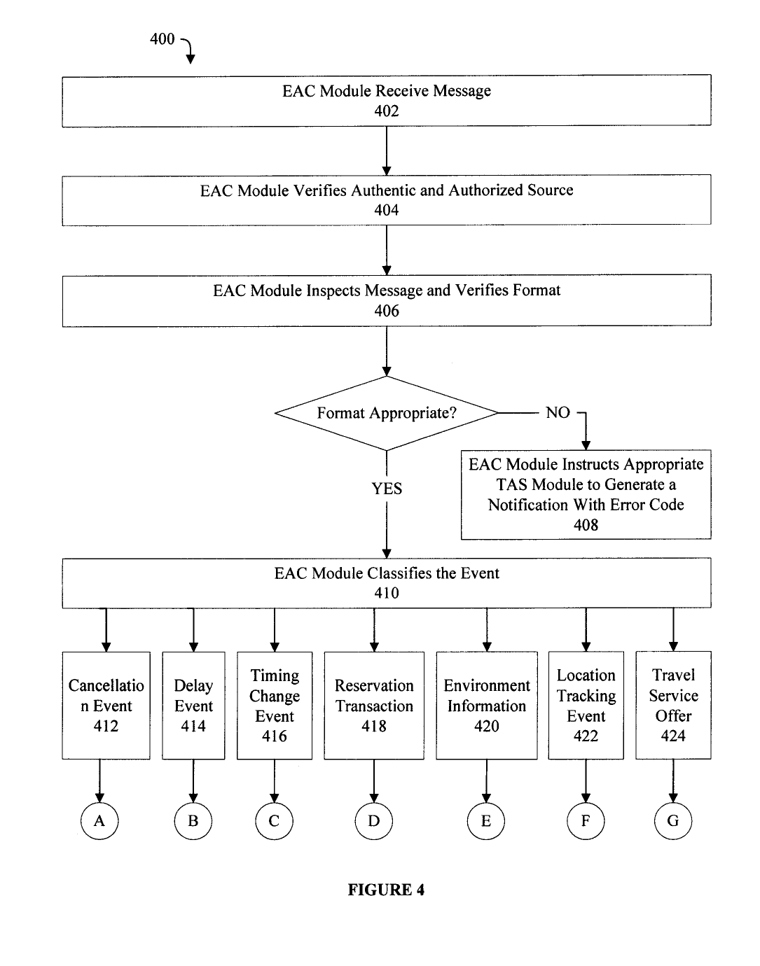

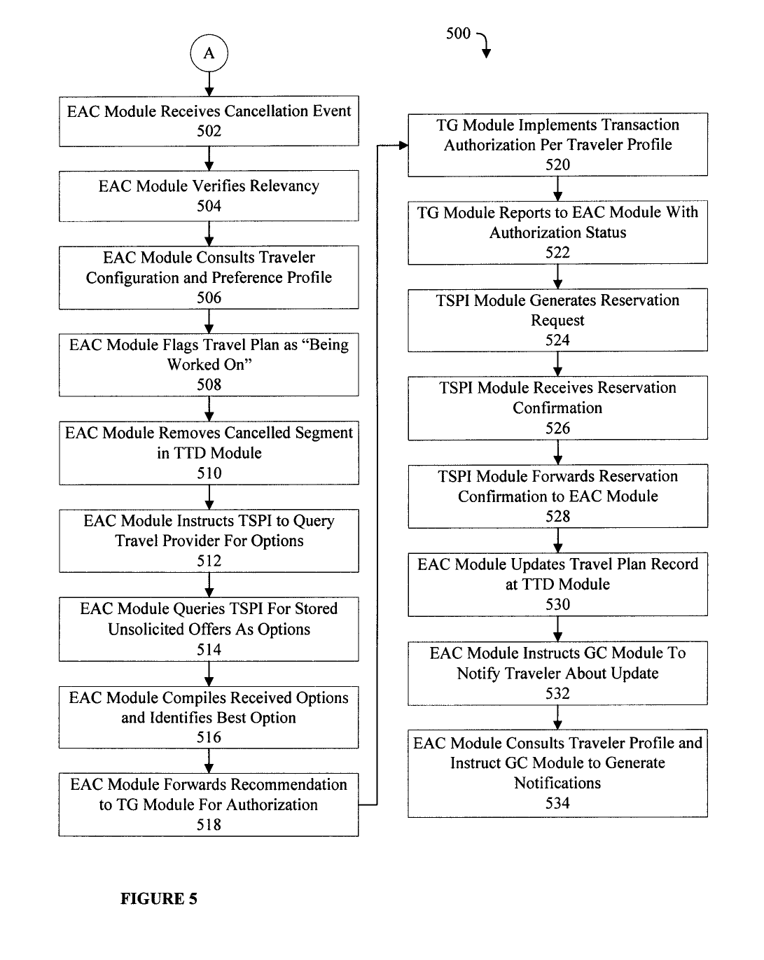

FIG. 4 further illustrates a flow of processing events received by the EAC module 400. At step 402, the EAC module receives a message. The message may be a reservation, an event, and/or an offer. The EAC module then verifies that the message is from an authentic and authorized source (step 404). For example, EAC module may verify that the source is authorized to send the type of message received. In step 406, the EAC module may then inspect the message and verify that the message contains a valid format and all the necessary fields associated with the type of message. If the message is not formatted appropriately, the EAC module may instruct the TAS module that received the message and forwarded it to the EAC module to generate a notification with an error code to the transmitting party (step 408). If the message is formatted correctly, the EAC module may classify the event (step 410). The message may be classified as a cancellation event (step 412), a delay event (step 414), a timing change event (step 416), a reservation transaction (step 418), environment information (step 420), a location tracking event (step 422), or a travel service offer (step 424). FIGS. 5-11 detail the process associated with each type of event classification.

FIG. 5 illustrates cancellation event processing 500 by the travel assistance system according to a particular embodiment. In step 502, the EAC module may receive a message detailing a cancellation event. The EAC module may verify the relevancy of the cancellation event in step 504. For example, a cancellation received from a service provider that impacts a travel plan may be considered relevant (e.g., cancellation of a transportation segment, cancellation of a show, cancellation of a seminar, or the like). A cancellation event may be considered irrelevant if the event does not have an impact on existing reservation being tracked for TAS subscribers. For example, the cancellation of a flight that does not include any TAS subscribers may be considered irrelevant. Once the EAC module verifies the cancellation event as relevant, the EAC module may consult the traveler configuration and preference profile of the TCPD module (step 506) to associate the cancellation event with the appropriate traveler preferences. In step 508, the EAC module may flag the travel plan associated with the cancellation event as “being worked on.” This flag may avoid duplicate processing of the event and/or simultaneous processing of events associated with multiple segments. In step 510, the EAC module may remove the cancelled segment in the TTD module.

Next, in step 512, the EAC module may instruct the TSPI module to query the originating travel provider for alternative options. For example, where a cancelled segment is a train trip booked with Railway A, Railway A may be queried for alternative options provided by Railway A. Where the traveler preferences indicate that alternative service providers may be queried as well, the EAC module may query all other available service providers offering a similar service to the cancelled event. In step 514, the EAC module may also query the TSPI module for stored unsolicited offers that may be relevant to the cancellation event. The EAC module may then compile a listing of receive options available to substitute the cancelled service identified in the cancellation method in step 516. Further, in step 516, the EAC module may determine a best option based on the traveler configuration and preference profile data pulled in step 506. In step 518, the EAC module may forward the best option as a recommendation to the TG module for authorization.

In step 520, the TG module may implement transaction authorization as provided by the traveler profile. For example, a traveler profile may select to automatically book a determined best option without traveler authorization. In this manner, the traveler may be able to take advantage of a service that may be unavailable a moment later due to being sold out. Alternatively, a traveler profile may indicate that any best option must be approved by the traveler before the transaction associated with the best option is authorized. In step 522, the TG module may report the authorization status to the EAC module.

In step 524, the TSPI module may generate a reservation request for an authorized best option. The TSPI module may then transmit the reservation request to the TSPI agent associated with the service provider offering the best option. The TSPI agent may then approve or deny the request. If the request is approve, the TSPI agent may then communicate the approval to the TSPI module (step 526). The TSPI module may then forward the reservation confirmation to the EAC module in step 528. In step 530, the EAC module may update a travel plan record in the TDD module. In step 532, the EAC module may instruct the GC module to notify traveler about the updated travel plan record. At step 534, the EAC module may consult the traveler profile and instruct the GC module to generate notifications to a traveler community as per the traveler profile.

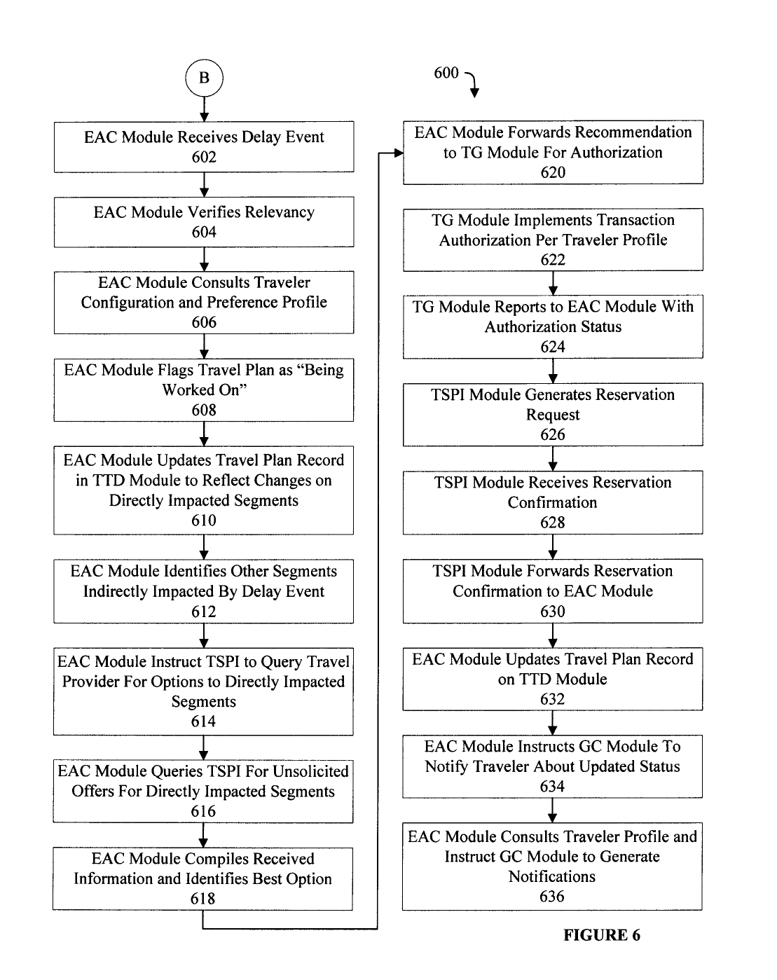

FIG. 6 illustrates delay event processing 600 by the travel assistance system according to a particular embodiment. In step 602, the EAC module may receive a message detailing a delay event. The EAC module may verify the relevancy of the delay event in step 604. For example, a delay event that does not result in a delay over a predefined threshold may not be considered relevant. Once the EAC module verifies the delay event as relevant alone with the travelers who are impacted by the event, the EAC module may consult the traveler configuration and preference profile of the TCPD module (step 606) to associate the delay event with the appropriate traveler preferences. In step 608, the EAC module may flag the travel plan associated with the delay event as “being worked on.” This flag may avoid duplicate processing of the event or simultaneous processing of events associated with multiple segments.

In step 610, the EAC module may update a travel plan record in the TTD module to reflect the changes the delay event may cause. In this manner, directly impacted travel segments may be identified. In step 612, the EAC module also identifies indirectly impacted travel segments. Indirectly impacted segments may be segments that do not need to be changed based on the delay event, but that may need to be changed if the travel segment affected by the delay event is replaced with a different travel segment. For example, where a flight delay occurs and a traveler has a car rental reservation at the destination, the car rental reservation does not necessarily need to be changed based on the delay event. However, the car rental reservation may be indirectly impacted if the delay event results in a rebooking of a flight to another destination in the same city (e.g., LaGuardia airport in New York is the original arrival destination and JFK airport in New York is the new arrival destination). In this example, the car rental reservation may be flagged as indirectly impacted by the delay event.

At step 614, the EAC module may instruct the TSPI module to query the originating travel provider for alternative options to the segment associated with the delay event. For example, where a delayed segment is a train trip booked with Railway A, Railway A may be queried for alternative options provided by Railway A. Where the traveler preferences indicate that alternative service providers may be queried as well, the EAC module may query all other available service providers offering a similar service to the delayed event. In step 616, the EAC module may also query the TSPI module for stored unsolicited offers that may be relevant to the directly impacted segment affected by the delayed event. In this manner, the TSPI query may be limited and more efficient in finding offers that related to the immediately impacted travel segments.

The EAC module may then compile a listing of receive options available to substitute the impacted travel segments (step 618). Further, in step 618, the EAC module may determine a best option based on the traveler configuration and preference profile data pulled in step 606. In step 620, the EAC module may forward the best option as a recommendation to the TG module for authorization.

The TG module may implement transaction authorization as provided by the traveler profile (step 622). For example, a traveler profile may select to automatically book a determined best option without traveler authorization. In this manner, the traveler may be able to take advantage of a service that may be unavailable a moment later due to being sold out. Alternatively, a traveler profile may indicate that any best option must be approved by the traveler before the transaction associated with the best option is authorized. In step 624, the TG module may report the authorization status to the EAC module.

In step 626, the TSPI module may generate a reservation request for an authorized best option. The TSPI module may then transmit the reservation request to the TSPI agent associated with the service provider offering the best option. The TSPI agent may then approve or deny the request. If the request is approve, the TSPI agent may then communicate the approval to the TSPI agent (step 628). The TSPI module may then forward the reservation confirmation to the EAC module in step 630. In step 632, the EAC module may update a travel plan record in the TTD module. In step 634, the EAC module may instruct the GC module to notify traveler about the updated travel plan record. At step 636, the EAC module may consult the traveler profile and instruct the GC module to generate notifications to a traveler community as per the traveler profile.

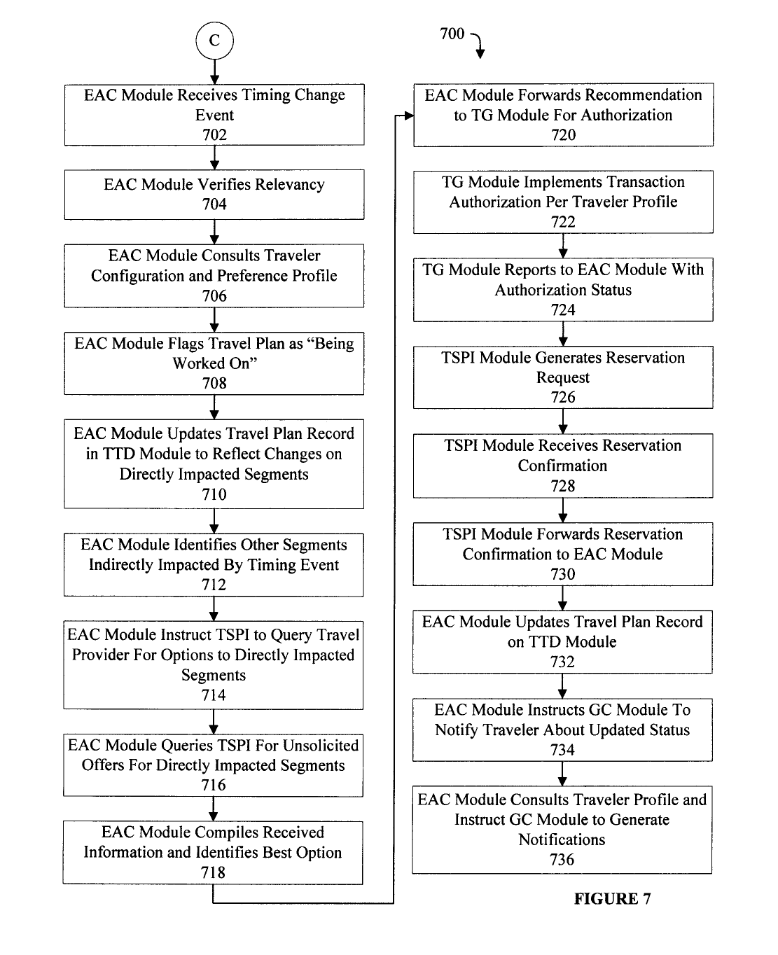

FIG. 7 illustrates timing change event processing 700 by the travel assistance system according to a particular embodiment. In step 702, the EAC module may receive a message detailing a timing change event. For example, a timing change event may refer to a class of events that will cause a travel segment to be associated with a different start and/or end time and/or date. By way of example, a timing change event may be a meeting attended by a traveler that is extended from 2 to 3 hours. The EAC module may verify the relevancy of the timing change event in step 704. For example, a timing change event that does not result in a timing change over a predefined threshold may not be considered relevant. Once the EAC module verifies the delay event as relevant, the EAC module may consult the traveler configuration and preference profile of the TCPD module (step 706) to associate the timing change event with the appropriate traveler preferences. In step 708, the EAC module may flag the travel plan associated with the timing change event as “being worked on.” This flag may avoid duplicate processing of the event or simultaneous processing of events associated with multiple segments.

In step 710, the EAC module may update a travel plan record in the TTD module to reflect the changes the timing change event may cause. In this manner, directly impacted travel segments may be identified. In step 712, the EAC module also identifies indirectly impacted travel segments. Indirectly impacted segments may be segments that are not directly involved in the timing change but may be impacted nonetheless. For example, where a timing change occurs and a 2 hour meeting is rescheduled to be 3 hours and the meeting is to take place in city A, while the traveler is scheduled to be on a bus in city B by a time not directly impacted by the timing change event. The bus travel may nonetheless be indirectly impacted when it becomes unlikely or impossible for the traveler to travel from city A to city B in the time allotted between the scheduled meeting and the departure time. In this example, the bus travel reservation may be flagged as indirectly impacted by the timing change event.

At step 714, the EAC module may instruct the TSPI module to query the originating travel provider for alternative options to the segment associated with the timing change event. For example, where a timing change segment is a meeting booked with Consultant A, Consultant A may be queried for alternative meeting options. Where the traveler preferences and travel segments indicate that alternative service providers may be queried as well, the EAC module may query all other available service providers offering a similar service to the segment affected by the timing change event. In step 716, the EAC module may also query the TSPI module for stored unsolicited offers that may be relevant to the directly impacted segment affected by the timing change event. In this manner, the TSPI query may be limited and more efficient in finding offers that related to the immediately impacted travel segments.

The EAC module may then compile a listing of receive options available to substitute the impacted travel segments (step 718). Further, in step 718, the EAC module may determine a best option based on the traveler configuration and preference profile data pulled in step 706. In step 720, the EAC module may forward the best option as a recommendation to the TG module for authorization.

The TG module may implement transaction authorization as provided by the traveler profile (step 722). For example, a traveler profile may select to automatically book a determined best option without traveler authorization. Alternatively, a traveler profile may indicate that any best option must be approved by the traveler before the transaction associated with the best option is authorized. In step 724, the TG module may report the authorization status to the EAC module.

In step 726, the TSPI module may generate a reservation request for an authorized best option. The TSPI module may then transmit the reservation request to the TSPI agent associated with the service provider offering the best option. The TSPI agent may then approve or deny the request. If the request is approve, the TSPI agent may then communicate the approval to the TSPI agent (step 728). The TSPI module may then forward the reservation confirmation to the EAC module in step 730. In step 732, the EAC module may update a travel plan record in the TTD module. In step 734, the EAC module may instruct the GC module to notify traveler about the updated travel plan record. At step 736, the EAC module may consult the traveler profile and instruct the GC module to generate notifications to a traveler community as per the traveler profile.

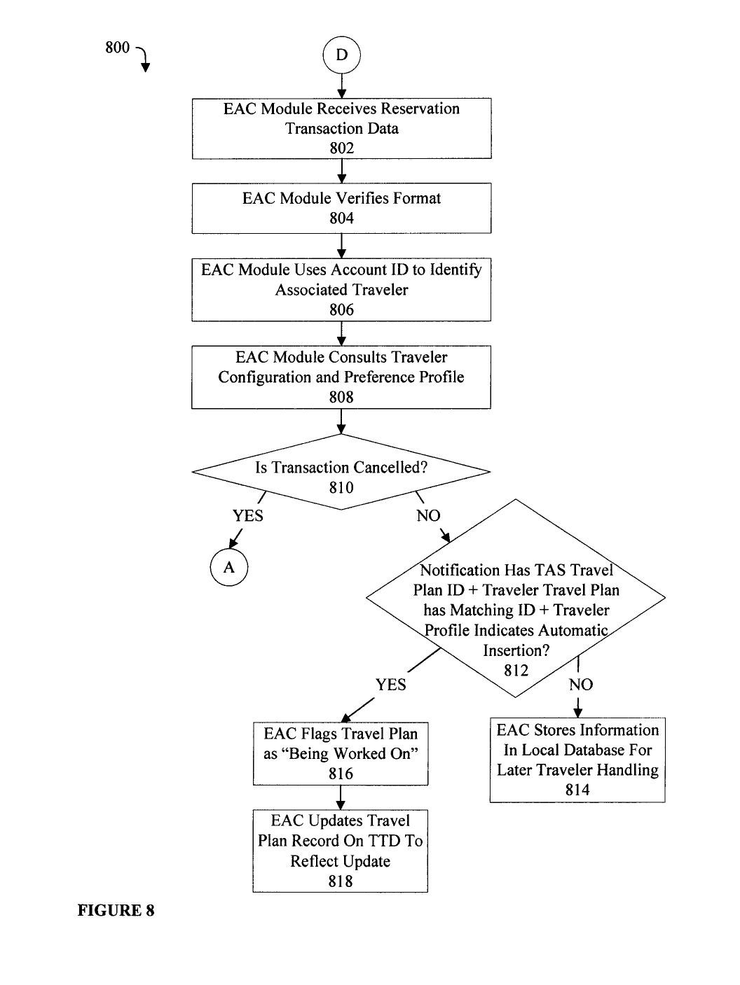

FIG. 8 illustrates reservation transaction processing 800 by the travel assistance system according to a particular embodiment. A reservation transaction may refer to a class of event such as reservation notifications from a TAS-aware service provider. Reservation notifications may include, for example, a notification of booking travel segments and/or a notification of canceling travel segments. In step 802, the EAC module may receive a reservation transaction data. The EAC module may verify the format of the reservation transaction as illustrated in FIG. 4. In step 806, the EAC module may use an account ID to identify the associated traveler. The EAC module may then consult the traveler configuration and preference profile (step 808) to associate the reservation transaction with the appropriate traveler preferences.

At step 810, the EAC module verifies that the reservation transaction is not a cancellation of a reservation. If the reservation transaction is a cancellation, EAC module may continue to process the reservation transaction as a cancellation event according the FIG. 5. If the reservation transaction is not a cancellation, the EAC module may verify that the reservation transaction contains a TAS travel plan ID, that the traveler has a travel plan associated with a matching travel plan ID, and the traveler profile indicates automatic insertion of transaction related information into the travel plan (step 812). If any of the elements of step 812 are missing, the EAC module may store the transaction related information in a local database for subsequent traveler handling via the TI module (step 814). If the elements of step 812 are present, the EAC module may flag the travel plan as “being worked on” (step 816). The EAC module may then update the travel plan record in the TTD module to reflect the reservation transaction data.

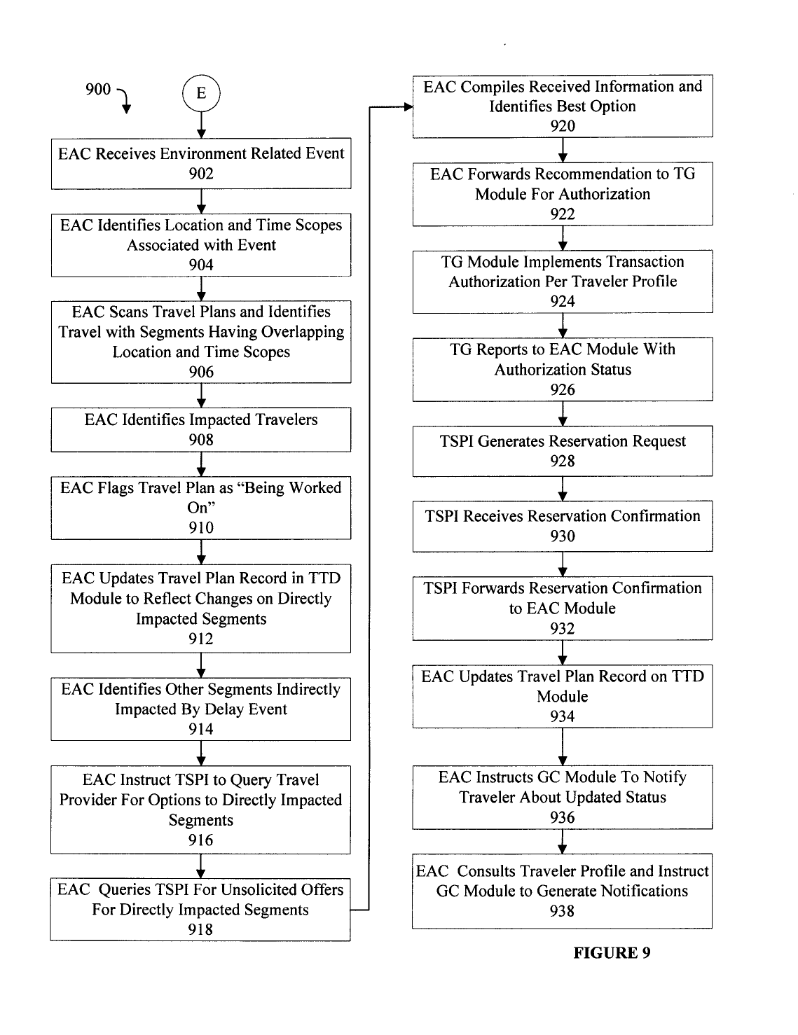

FIG. 9 illustrates environment event processing 900 by the travel assistance system according to a particular embodiment. In step 902, the EAC module may receive a message detailing an environment related event. An environment related event may include an event such as a road closure, traffic delay, severe weather warning, and the like. At step 904 the EAC module may identify a location scope and a time scope associated with the environment related event. In step 906, the EAC system may then scan travel plans and identify a travel plan having overlapping location and time scopes with the identified scopes of step 904. The EAC system may then identify impacted travelers based on the impacted travel plans (step 908). In step 910, the EAC module may flag the travel plan associated with the environment related event as “being worked on.” This flag may avoid duplicate processing of the event or simultaneous processing of events associated with multiple segments.

In step 912, the EAC module may update a travel plan record in the TTD module to reflect the changes the environment related event may cause. In this manner, directly impacted travel segments may be identified. In step 914, the EAC module also identifies indirectly impacted travel segments. Indirectly impacted segments may be segments that do not need to be changed based on the environment related event, but that may need to be changed if the travel segment affected by the environment related event is replaced with a different travel segment. For example, where severe weather causes a flight delay and a traveler has a car rental reservation at the destination, the car rental reservation does not necessarily need to be changed based on the delay event. However, the car rental reservation may be indirectly impacted if the delay event results in a rebooking of a flight to another destination in the same city (e.g., LaGuardia airport in New York is the original arrival destination and JFK airport in New York is the new arrival destination). In this example, the car rental reservation may be flagged as indirectly impacted by the environment related event.

At step 916, the EAC module may instruct the TSPI module to query the originating travel provider for alternative options to the segment associated with the environment related event. For example, where a travel segment directly impacted by an environment related event is a car rental reservation booked with Company A, Company A may be queried for alternative options provided by Company A. Where the traveler preferences indicate that alternative service providers may be queried as well, the EAC module may query all other available service providers offering a similar service to the travel segment affected by the environment related event. In step 918, the EAC module may also query the TSPI module for stored unsolicited offers that may be relevant to the directly impacted segment affected by the environment related event. In this manner, the TSPI query may be limited and more efficient in finding offers that related to the immediately impacted travel segments.

The EAC module may then compile a listing of received options available to substitute the impacted travel segments (step 920). Further, in step 920, the EAC module may determine a best option based on the traveler configuration and preference profile data. In step 922, the EAC module may forward the best option as a recommendation to the TG module for authorization.

The TG module may implement transaction authorization as provided by the traveler profile (step 924). For example, a traveler profile may select to automatically book a determined best option without traveler authorization. In this manner, the traveler may be able to take advantage of a service that may be unavailable a moment later due to being sold out. Alternatively, a traveler profile may indicate that any best option must be approved by the traveler before the transaction associated with the best option is authorized. In step 926, the TG module may report the authorization status to the EAC module.

In step 928, the TSPI module may generate a reservation request for an authorized best option. The TSPI module may then transmit the reservation request to the TSPI agent associated with the service provider offering the best option. The TSPI agent may then approve or deny the request. If the request is approve, the TSPI agent may then communicate the approval to the TSPI agent (step 930). The TSPI module may then forward the reservation confirmation to the EAC module in step 932. In step 934, the EAC module may update a travel plan record in the TTD module. In step 936, the EAC module may instruct the GC module to notify traveler about the updated travel plan record. At step 938, the EAC module may consult the traveler profile and instruct the GC module to generate notifications to a traveler community as per the traveler profile.

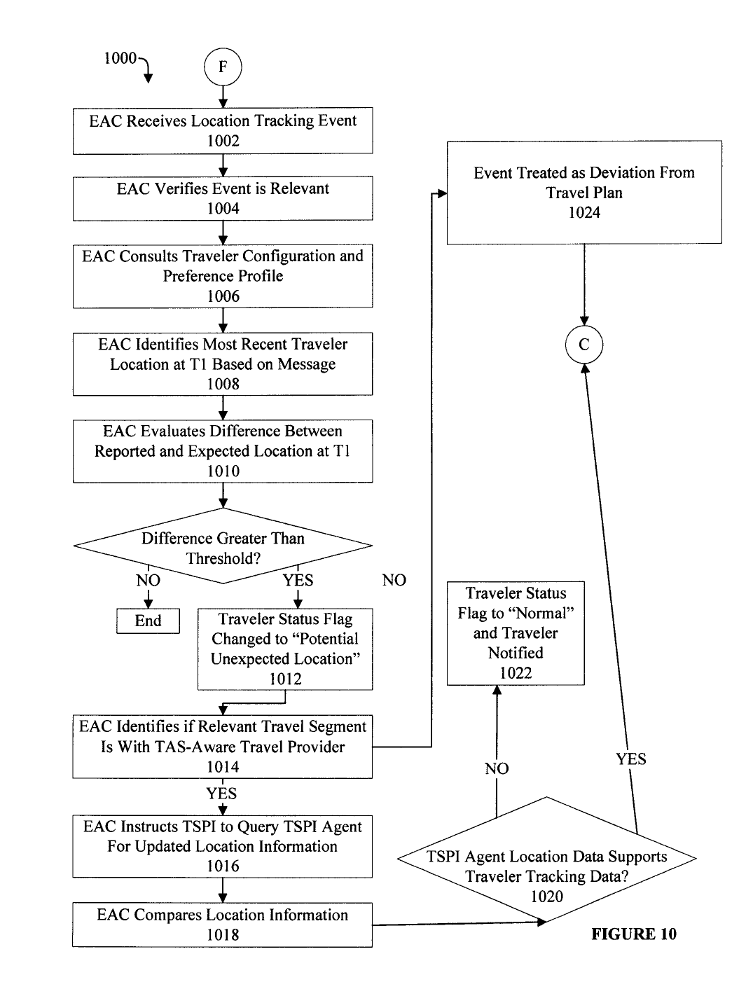

FIG. 10 illustrates location tracking event processing 1000 by the travel assistance system according to a particular embodiment. In step 1002, EAC module may receive a location tracking event. A location tracking event may refer to a class of events related to locations tracking information received via the TI module. In step 1004, the EAC module may determine whether a location tracking event is relevant. A location tracking event may be relevant where a location tracking event indicates a traveler is associated with a current travel plan. At step 1006, the EAC module may consult traveler configuration and preference profile to associate applicable traveler preferences to the location tracking event.

The EAC module may then identify a most recent traveler location at a first time based on a received location tracking message (step 1008). The EAC module may then evaluate the different between the reported location in step 1008 and an expected location at a first time (step 1010). If the difference between the reported location and the expected location is not greater than a predetermined threshold, the EAC module determines that the location tracking event does not affect the travel plan for a particular traveler. If the difference between the reported location and the expected location is greater than a predetermined threshold, the EAC module may flag the travel segment status as “potential unexpected location” (step 1012).

At step 1014, the EAC module may identify if the relevant travel segment affected by the location tracking event is with a TAS-aware travel provider. If so, the EAC may instruct the TSPI module to query the TSPI agent for updated location information. For example, where a location tracking event indicates that a traveler is at location A at time T1 when the travel plan indicates that a traveler should be at location B, the TSPI agent that is queried may indicate that the traveler is on a plane awaiting take off and therefore, still at location A. At step 1018, the EAC module may compare the updated location information provided by the TSPI agent via the TSPI module to the location tracking event data. If the comparison in step 1018 indicates that location information received from the TSPI agent supports location information received from traveler tracking data in step 1020, the event may be treated as a deviation from a travel plan and the processing may proceed according to FIG. 7.

Step 1020 may also determine that TSPI Agent location data does not support traveler tracking data where telematics data indicates that an anticipated arrival time is not possible based on external factors, such as traffic, construction, and accident, or other events. For example, if a passenger in a vehicle is on a way to a reservation, such as a dinner reservation or a travel reservation, and EAC module determines that the TSPI Agent location data (e.g., telematics data) does not support that a traveler begin tracked will arrive to the reservation on time, the event may be treated as a deviation from a travel plan (step 1024). Accordingly the TAS may then present an option to the traveler to confirm this deviation and accept remuneration or rebooking of the reservation in exchange for freeing up the seat, table, or other reserved spot, for another traveler.

If the comparison in step 1018 indicates that the location information received from a TSPI agent does not support location information received in traveler tracker data in step 1020, the EAC module may set the traveler status flag to “normal,” and the traveler may be notified (step 1022). Moreover, the TAS-aware service provider may be notified of the anticipated arrival time based on the location information in order to prepare the arrival of the traveler. For example, a restaurant may prepare a table and have drinks waiting upon arrival of a traveler. In other examples, a transportation provider may provide amenities according to a traveler profile upon arrival of a traveler.

The EAS module also may instruct the TSPI module to contact the TAS-aware service provider for further information before proceeding. If the EAC identifies that the relevant travel segment is with a TAS-unaware service provider in step 1014, the location tracking event may be treated as a deviation from a travel plan and processing may proceed according to FIG. 7 (step 1024).

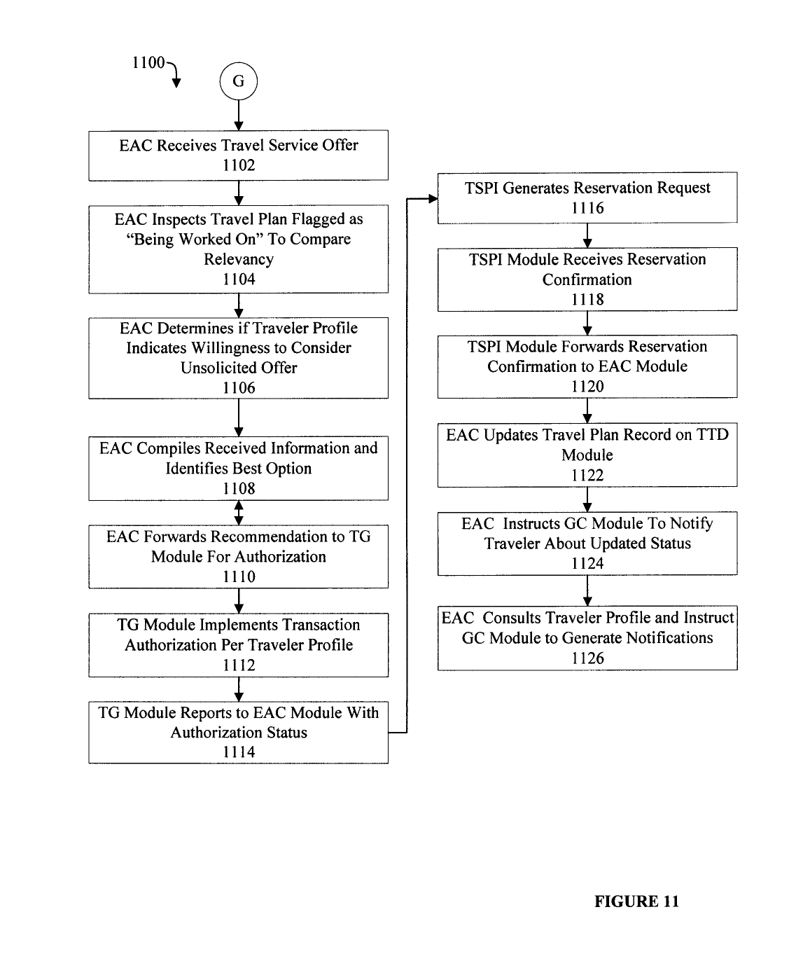

FIG. 11 illustrates travel service offer processing 1100 by the travel assistance system according to a particular embodiment. In step 1102, the EAC module may receive a message detailing a travel service offer. For example, a travel service offer may refer to a class of events that indicates availability of travel-related services that may be desired by a subset of travelers. In step 1104, the EAC may inspect a travel plan that is flagged as “being worked on.” The EAC module may then inspect a traveler profile associated with the TAS module to determine if a traveler is willing to consider unsolicited offers (step 1106).

In step 1108, the EAC module may incorporate the offer into identifying a best option for a travel segment flagged as “being worked on.” Where the offer is selected as the best option in step 1108, the EAC module may forward the best option as a recommendation to the TG module for authorization (step 1110). The TG module may implement transaction authorization as provided by the traveler profile (step 1112). For example, a traveler profile may select to automatically book a determined best option without traveler authorization. Alternatively, a traveler profile may indicate that any best option must be approved by the traveler before the transaction associated with the best option is authorized. In step 1114, the TG module may report the authorization status to the EAC module.

In step 1116, the TSPI module may generate a reservation request for an authorized best option. The TSPI module may then transmit the reservation request to the TSPI agent associated with the service provider offering the best option. The TSPI agent may then approve or deny the request. If the request is approve, the TSPI agent may then communicate the approval to the TSPI agent (step 1118). The TSPI module may then forward the reservation confirmation to the EAC module in step 1120. In step 1122, the EAC module may update a travel plan record in the TTD module. In step 1124, the EAC module may instruct the GC module to notify traveler about the updated travel plan record. At step 1126, the EAC module may consult the traveler profile and instruct the GC module to generate notifications to a traveler community as per the traveler profile.

The following is an example of the TAS system in use. The following example is meant to be exemplary only and in no way limits the scope of the embodiments to this particular example.

For example, a new TAS provider setting up the service may perform the following functions to enable successful communication between the TAS and the service provider. In this example the TAS service provider is referred to as TAS-SP-1, and the service provider as Travel-Comp-ABC (which is an Airline). TAS-SP-1 may provide the following information to TAS:

A. Addressing
IP address (or Fully Qualified Domain Name) associated with the TAS-TSPI module at TAS-SP-1=192.168.1.100
IP address (or Fully Qualified Domain Name) associated with the TAS-TSPI Agent at Travel-Comp-ABC=192.168.3.100

B. Security
IPSec is to be used to protect traffic between TAS-SP-1 and Travel-Comp-ABC. An IPSec tunnel is created between the two sides.
IPSec tunnel point on the TAS-SP-1 side=192.168.4.100
IPSec tunnel point on the Travel-Comp-ABC side=192.168.5.100
Shared key for IPSec configuration=ABCDEFG12345
Criteria for traffic transported over the tunnel=Traffic between IP addresses 192.168.1.100 and 192.168.3.100
IPSec phase 1 parameters: hash md5 (a pre-shared authentication)
IPSec phase 2 parameters: ESP Encryption=ESP-DES, ESP Authentication=ESP md5-hmac

C. Types and details of transactions
TAS-SP-1 and Travel-Comp-ABC agree on the types of the transactions, and the format of the corresponding requests and responses, such that the two sides are in agreement on the implementation details of the interface. The following table, Table 1, list identifies the transactions supported on the interface:

TABLE 1

| Message | Description |
|---|---|
| STQR-1 | Query for the status associated with a particular flight (Message source: TAS |
| | provider, Message destination: travel provider) |
| STRP-1 | Response to the Query for the status associated with a particular flight (Message |
| | source: travel provider, Message destination: TAS provider) |
| STQR-2 | Query for the status associated with flights departing from a particular airport within |
| | a specific time frame (Message source: TAS provider, Message destination: travel |
| | provider) |
| STRP-2 | Response to the Query for the status associated with flights departing from a |
| | particular airport within a specific time frame. The status response includes the |
| | arrival time. (Message source: travel provider, Message destination: TAS provider) |
| EVNT-1 | Notification about a change in the departure or arrival time for one or more flight. |
| | (Message source: travel provider, Message destination: TAS provider) |
| RSEVN | Notification about a completed reservation. (Message source: travel provider, |
| T-1 | Message destination: TAS provider) |
| RSQR-1 | Query for availability of seats and other information on a flight between two points |
| | within a specified time frame. (Message source: TAS provider, Message destination: |
| | travel provider) |
| RSQP-1 | Response to the Query for availability of seats and other information on a flight |
| | between two points within a specified time frame. (Message source: travel provider, |
| | Message destination: TAS provider) |
| RSRQ-1 | Request to make a reservation. (Message source: TAS provider, Message |
| | destination: travel provider) |
| RSRP-1 | Response to the Request to make a reservation. (Message source: travel provider, |
| | Message destination: TAS provider) |
| RSQR-2 | Query for the reservation status and travel status associated with a traveler, using |
| | TAS Transaction ED. (Message source: TAS provider, Message destination: travel |
| | provider) |
| RSQP-2 | Response to the Query for the reservation status and travel status associated with a |
| | traveler, using TAS Transaction ID. (Message source: travel provider, Message |
| | destination: TAS provider) |

An example of the format for RSQR-2 and RSQP-2, when XML is used as the coding environment, is included below:

### RSQR-2:

```
<TasQueryRequest>
  <QueryOrigin>192.168.1.100</QueryOrigin>
  <QueryDestination>192.168.3.100</QueryDestination>
  <TransactionCode> RSQR-2</TransactionCode>
  <QueryTargetTasTransactionId>TASxyz134abcdd123
  </QueryTargetTasTransactionId>
</TasQueryRequest>
```

### RSQP-2:

```
<TasQueryResponse>
  <QueryOrigin>192.168.3.100</QueryOrigin>
  <QueryDestination>192.168.1.100</QueryDestination>
  <TransactionCode>RSQP-2</TransactionCode>
  <QueryTargetTasTransactionId>TASxyz134abcdd123
  </QueryTargetTasTransactionId>
  <TransactionStatus> Confirmed</TransactionStatus>
  <ServiceStatus> Off-Plan</ServiceStatus>
    <StatusUpdateLevel1>DepartureDelay</StatusUpdateLevel1>
    <StatusUpdateLevel1>Description>Departure Delay 30Min
    NewDeparture Time 19:45:00 on 5/20/2013
    </StatusUpdateLevel1Description>
    <StatusUpdateLevel2>Description>Arrival Delay 45Min
    New ArrivalTime 21:55:00 on 5/20/2013
    </StatusUpdateLevel2Description>
</TasQueryResponse>
```

The following is an example of information agreed upon between a TAS provider and an information service provider to enable successful communication between TAS and the information service provider. In this example, the TAS service provider is referred to as TAS-SP-1 and the information provider is referred to as Info-Provider-Traffic-123.

A. Addressing
IP address (or Fully Qualified Domain Name) associated with the TAS-ECI module at TAS-SP-1=192.168.15.100
IP address (or Fully Qualified Domain Name) associated with the TAS-ECI Agent at Info-Provider-Traffic-123=192.168.16.100

B. Security
IPSec is to be used to protect traffic between TAS-SP-1 and Info-Provider-Traffic-123. An IPSec tunnel is created between the two sides.
IPSec tunnel point on the TAS-SP-1 side=192.168.17.100
IPSec tunnel point on the Info-Provider-Traffic-123 side=192.168.18.100
Shared key for IPSec configuration=WXYZEFG12345
Criteria for traffic transported over the tunnel=Traffic between IP addresses 192.168.15.100 and 192.168.16.100
IPSec phase 1 parameters: hash md5 (a pre-shared authentication)
IPSec phase 2 parameters: ESP Encryption=ESP-DES, ESP Authentication=ESP md5-hmac

C. Types and details of transactions
TAS-SP-1 and Info-Provider-Traffic-123 agrees that the communication between them supports the following transactions:

TABLE 2

| Message | Description |
|---|---|
| SCDL-1 | Scope declaration, from TAS-SP-1 to Info-Provider- |
| | Traffic-123 |
| | The purpose of this message is for TAS-SP-1 to |
| | identify the information scope it is currently |
| | interested in. For example, if the TAS-SP-1 is |
| | currently tracking only subscribers on the east |
| | coast, the scope will reflect that the TAS-SP-1 |
| | is interested in receiving traffic events only |
| | related to the east coast. |
| SCEVRP-1 | Scope Event Report, from the Info-Provider-Traffic- |
| | 123 to the TAS-SP-1. |
| | This report provides a list of events relevant to |
| | the scope previously identified by TAS-SP-1 I the |
| | SCDL-1. The report provides the following |
| | information: |
| | Road Identifier (for example NY-95 North) |
| | Road segment impacted (for example Exit 12 to exit |
| | 15 [Coordinates North nn degrees mm, West oo |
| | degrees pp to North ww degrees xx, West yy degrees zz) |
| | Impact Type: Delay |
| | Impact Quantitative: 20 Minutes |
| | Impact Start Date/Time: 5/12/2013 09:00 |
| | Impact End Date/Time: 5/12/2013 13:00 |
| | Impact Description: Road Work - 20 minutes delay 9:00 |
| | AM-1:00PM on Exit 12 to Exit 15 on NY-95 North |

The following is an example of a new subscriber to the TAS service setting up a profile and creating a travel plan. The subscriber may be prompted to create a username and password. The username may be unique. The subscriber may create a username, such as JohnSmith, and a password, such as JohnSmithPassword. The subscriber may be directed to identify a payment method for the TAS service. The subscriber may then be assigned a TAS account ID, such as TAS-NY-9870001234. An email account on the TAS email server may be created for the subscriber, such as username@TASprovider.com (JohnSmith@TASprovider.com). The subscriber may also be asked to identify one or more of his email addresses to receive email notifications. The subscriber may be asked to enter a mobile device number if the subscriber desires to receive notifications via the mobile device related to the TAS. The subscriber may be asked to populate a “community” list. A community list may be composed of contact information for people to receive notifications associated with travel plans. In this example, the subscriber may enters: JohnSmith_Friend_{—}1@emailprovider.com and phone (123)456-7890; JohnSmith_Friend_{—}2@emailprovider.com; JohnSmith_Boss_{—}1@ work-email.com; JohnSmith_CoWorker_{—}1@work-email.com and phone (234)567-8901; and JohnSmith_family_member_{—}1@emailprovider.com and phone (123)789-0123 (Travel Plan Administrator). The subscriber may also select to assign travel plan administration privilege to a family member (email JohnSmith_family_member_{—}1@emailprovider.com), which allows the family member to make changes related to the subscriber's TAS travel plan.

The subscriber may also identify a willingness to enable TAS-traveler location tracking agent on one subscriber mobile devices. The subscriber may also be asked to identify preferred or previously-used service providers. In the subscriber preferences, the subscriber may also identify a preference regarding handling exceptions related to travel events. For example, the subscriber may identify that he wants the TAS system to automatically book a new hotel reservation, if the original reservation is canceled), as long as the cost of the new reservation is + or −5% of the cost of the original reservation.

Once a subscriber has set up a profile and preferences, a TAS subscriber may create a travel plan. For example, a subscriber may indicate travel plans according to the following table:

TABLE 3

| Start Date | Start Time | End Date | End Time | Description |
|---|---|---|---|---|
| 1/1/14 | 6:00AM | 1/1/14 | 6:30AM | Local train from |
| | | | | Stamford, CT to New |
| | | | | York City, NY |
| 1/1/14 | 6:45AM | 1/1/14 | 9:15AM | Train from New York |
| | | | | City to Baltimore |
| 1/1/14 | 9:15AM | 1/1/14 | 10:00AM | Driving |
| 1/1/14 | 10:00AM | 1/1/14 | 6:00PM | Meeting |
| 1/1/14 | 6:00PM | 1/1/14 | 6:30PM | Driving |
| 1/1/14 | 6:30PM | 1/1/14 | 7:00AM | Hotel |

The subscriber may log into a TAS account and create the above-described travel plan and assign a travel plan ID to the trip. Once the subscriber purchases travel reservations for the trip, the traveler may either manually enter the information (if the reservation is made, for example at a ticket counter that does not send information to TAS) or have the information automatically added to the travel plan. For example, a subscriber may use a TAS-aware discount travel booking service to book the ticket for the train from New York City to Baltimore Md. During the online booking, the web interface of discount travel booking service may prompt the subscriber to enter a TAS account ID if one is available. For convenience, the discount travel booking service may save the TAS account ID in the traveler specific profile used by the travel provider. Also the traveler may be prompted for a TAS travel plan ID if he wants to associate his reservation with a TAS travel plan ID.

When the subscriber confirms the reservation, the discount travel booking service may send (using its TAS-TSPI agent) a notification that includes the reservation information, to the TAS service provider TAS-TSPI module. The discount travel booking service may follow the format agreed on between the two sides. For example, the notification may include the following:

```
<TasResvNotification>
  <NotfOrigin>192.168.200.100</NotfOrigin>
  <NotfDestination>192.168.1.100</NotfDestination>
  <TransactionCode> RSEVNT-1</TransactionCode>
  <TasAccountId> TAS-NY-9870001234</TasAccountId>
  <TasTravePlanID> 1234</TasTravePlanID >
  <TasTransactionid>TAS1234fff65478</TasTransactionId>
  <ReservationType>Train</ReservationType>
  <ReservationProviderLevel-1>Direct Travel
  Booking</ReservationProviderLevel-1>
  <ReservationProviderLevel-2> BXYZ Trak Railway
  </ReservationProviderLevel-2>
  <ReservationDescriptor-A>04022013</ReservationDescriptor-A>
  <ReservationDescriptor-B>06:45</ReservationDescriptor-B>
  <ReservationDescriptor-C>04022013</ReservationDescriptor-C>
  <ReservationDescriptor-D>09:15</ReservationDescriptor-D>
</TasResvNotification>
```

When the TSPI module on the TAS manager receives the notification, it may confirm that such notification is compliant with the currently active local filtering rule. The current filter rules may allow all transactions that contain a particular reservation notification (those with Transaction Code=RSEVNT-1). Accordingly, the TSPI may forward the reservation notification to the EAC module. The EAC module may verify that the received information in the notification is appropriately formatted.

The EAC module may then inspect the notification and identify the TAS account ID as TAS-NY-9870001234 which belong to the TAS subscriber John Smith. The EAC module may also identify that the reservation notification includes a TAS travel plan ID and inspect the subscriber record thereby confirming an existing plan with a matching TAS Travel Plan ID. The EAC module may then consult the traveler configuration and preference profile and identify that the traveler preference is to automatically populate a reservation notification into an existing TAS travel plan. The EAC module may add the new travel segment to the identified travel plan. EAC module may rely on the information in the notification to identify the location in the travel plan where to insert the new segment.

The subscriber may also input meeting details via the TI module. The subscriber may also utilize online booking through a hotel chain website, where the hotel chain is a TAS-aware service provider. When the reservation is confirmed using the hotel chain website, a notification that includes the reservation information may be sent to TAS via the TSPI module. The hotel chain may follow the format agreed upon between the hotel chain and TAS. At this point, the travel arrangements have been made and provided to TAS regarding the subscriber's travel plan. Accordingly, when the subscriber accesses TAS via the TI module, the travel plan may appear as follows:

TABLE 4

| Traveler Name: John Smith | | | | | Traveler TAS ID: TAS-NY-9870001234 | | |
|---|---|---|---|---|---|---|---|
| TAS Travel Plan Nmae: xyz trip | | | | | TAS Travel Plan ID: 1234 | | |
| Segment | Start | Start | End | End | TAS | Non TAS | Comments/ |
| ID | Date | time | Date | Time | Provider | Provider | Other |
| 1 | 1/1/14 | 06:00 | 1/1/14 | 06:30 | | Light | |
| | | | | | | Commute | |
| | | | | | | Railway | |
| 2 | 1/1/14 | 06:45 | 1/1/14 | 09:15 | Direct Travel | | Train number 123 |
| | | | | | Booking | | |
| | | | | | (Booking) | | |
| | | | | | Trak Railway | | |
| | | | | | (Transport) | | |
| 3 | 1/1/14 | 09:15 | 1/1/14 | 10:00 | | | Driving from Baltimore, MD |
| | | | | | | | to Ashburn, VA. |
| | | | | | | | Location coordinates |
| | | | | | | | or address information |
| 4 | 1/1/14 | 10:00 | 1/1/14 | 18:00 | | | Meeting in Ashburn, VA - |
| | | | | | | | Location coordinates or |
| | | | | | | | address information. |
| | | | | | | | Notification community for |
| | | | | | | | this segment: JohnSmith_ |
| | | | | | | | CoWorker_1@work-email.com |
| 5 | 1/1/14 | 18:00 | 1/1/14 | 18:30 | | | Driving from Ashburn, VA to |
| | | | | | | | Hotel in Vienna, VA. Location |
| | | | | | | | coordinates or address |
| | | | | | | | information |
| 6 | 1/1/14 | 18:30 | 1/1/14 | 7:00 | Hotel-ABC | | Guaranteed late arrival only till |
| | | | | | | | 7:00 PM. Notification |
| | | | | | | | community for this segment: |
| | | | | | | | JohnSmith_family_member_1 |
| | | | | | | | @emailprovider.com |

The subscriber may then activate the travel plan on the TAS. The TAS may begin tracking the travel plan of John Smith illustrated in Table 4. The TAS may being tracking the segments of the travel plan before the start date and time of the travel plan. In this manner TAS may track any events that not only affect a current travel plan but also events that may affect a future travel plan.

The EAC module may instruct the TSPI module that it is interested in receiving information regarding reservation status from service provider Direct Travel Booking, related to any cancellation. Further, the EAC module may regularly instruct the TSPI module to query Direct Travel Booking about the TAS transaction ID to confirm that the reservation is still active. The rate of query may be configurable in the TAS system. Also, the EAC module may instruct the TSPI module that it is interested in receiving information regarding the progress of train number 123 on 1/1/2014. In the above-described example, no events may be detected until 9:15 a.m. on 1/1/14.

At 8:30 a.m., sometime before the start of segment 3, the EAC module may instruct the ECI module that it is interested in receiving any traffic/driving related events in the area between Baltimore and Ashburn. If the EAC has issued previous similar instruction (based on the need to track other travelers), no new request may be required. In this manner the number of request may be reduced. At 9:15 a.m., the subscriber, John Smith may start to drive from Baltimore towards Ashburn with a mobile device that includes an enabled traveler location tracking agent. At 9:30 a.m., the EAC module may identify that location information forwarded from the TI module suggests that the subscriber is not making the expected progress towards his destination. Also, the ECI agent at Info-Provider-Traffic-123 may forward traffic report to the ECI module. The EAC may then receive the forwarded traffic information from the ECI module suggesting a road closure between Baltimore and Ashburn. The EAC module may verify a preference profile for instruction regarding preference in handling such situation. In this example, John Smith may indicate a preference to use an SMS message. Accordingly, TAS may send an SMS message alerting the subscriber about this event and delay. The subscriber may respond to the SMS message via SMS message, which may then be intercepted by the GC module for processing, or via a web address sent in the message to the subscriber, which may then be processed at the ECI module. The response may then be sent to the EAC module for processing. The response may include location tracking data. The delay and location data may then be processed to generate a message according to the preferences of the subscriber. In this example, the subscriber may prefer that a co-worker be alerted of any delay to handle any client relations that may be impacted by the delay.

The subscriber may arrive at the location of his meeting in Ashburn, and the TLT agent may then report such information to the TI module, which forwards the information to the EAC module. The EAC module may then update the TTD module to reflect the updated time in the travel plan. At this point, the travel plan may appear as illustrated below:

TABLE 5

| TravelerName: John Smith | | | | | Traveler TAS ID: TAS-NY-9870001234 | | |
|---|---|---|---|---|---|---|---|
| TAS Travel Plan Name: xyz trip | | | | | TAS Travel Plan ID: 1234 | | |
| Seg. | Start | Start | End | End | TAS | Non TAS | Comments/ |
| ID | Date | time | Date | Time | Provider | Provider | Other |
| 1 | 1/1/14 | 06:00 | 1/1/14 | 06:30 | | Light | |
| | | | | | | Commute | |
| | | | | | | Railway | |
| 2 | 1/1/14 | 06:45 | 1/1/14 | 09:15 | Direct Travel | | Train number 123 |
| | | | | | Booking | | |
| | | | | | (Booking) | | |
| | | | | | Trak Railway | | |
| | | | | | (Transport) | | |
| 3 | 1/1/14 | 09:15 | 1/1/14 | [symbol] | | | Driving from Baltimore, |
| | | | | 10:45 | | | MD to Ashburn, VA. |
| | | | | | | | Location coordinates or |
| | | | | | | | address information |
| 4 | 1/1/14 | [symbol] | 1/1/14 | 18:00 | | | Meeting in Ashburn, |
| | | 10:45 | | | | | VA - Location |
| | | | | | | | coordinates or address |
| | | | | | | | information. |
| | | | | | | | Notification community |
| | | | | | | | for this segment: |
| | | | | | | | JohnSmith_CoWorker_ |
| | | | | | | | 1@work-email.com |
| 5 | 1/1/14 | 18:00 | 1/1/14 | 18:30 | | | Driving from Ashburn, |
| | | | | | | | VA to Hotel in Vienna, |
| | | | | | | | VA. Location |
| | | | | | | | coordinates or address |
| | | | | | | | information |
| 6 | 1/1/14 | 18:30 | 1/1/14 | 7:00 | Hotel-ABC | | Guaranteed late arrival |
| | | | | | | | only till 7:00 PM. |
| | | | | | | | Notification community |
| | | | | | | | for this segment: |
| | | | | | | | JohnSmith_family_member_1 |
| | | | | | | | @emailprovider.com |

The subscriber may proceed with his meeting. The meeting may extend over the originally scheduled time beyond the guaranteed late arrival time of the hotel at 7:00 p.m. Due to a major local event, the Hotel-ABC may cancel the subscriber's reservation. Accordingly, and the TSPI agent on the Hotel-ABC side may send a reservation cancellation notification to the TSPI module. The cancellation notification may be allowed through the local filter on the TSPI module and be forwarded to the EAC module. The EAC module may flag the travel plan as “Being worked On.” The EAC module may then update the travel plan record in TTD module to remove the segment associated with the canceled reservation.

The EAC module may instruct the TSPI module to query the travel provider Hotel-ABC TAS-TSPI agent for options related to room availability. Hotel-ABC may responds with no availability. EAC module may then instruct the TSPI module to query for received unsolicited offers for a hotel room in the Vienna area, within 3 Miles of original hotel location as specified by the subscriber profile. The EAC module may compile the received information and identify a best option based on distance, price, and user reviews. The EAC module may then forward the recommendation to TG module to follow the preference identified by the subscriber profile in authorizing the transaction. In this example, the subscriber may have enabled auto reservation, thereby authorizing a new reservation that is compliant to the two conditions (cost and distance relative to original reservation). The EAC module may then instruct the TSPI module to confirm the new reservation. After completing the confirmation, the EAC module may update the travel plan record on the TTD module to add/update the segment associated with the new reservation. The ‘Being worked On” flag may be reset on the travel plan, and the traveler may be notified. Other traveler community members may also be notified about this event, per the traveler preferred action. In this example. the subscriber family member may be notified about the hotel change.

It is to be appreciated that the set of instructions, e.g., the software, which configures the computer operating system to perform the operations described above may be contained on any of a wide variety of media or medium, as desired. Further, any data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by a computer.

In the preceding specification, various preferred embodiments have been described with references to the accompanying drawings. It will, however, be evident that various modifications and changes may be made thereto, and additional embodiments may be implemented, without departing from the broader scope of invention as set forth in the claims that follow. The specification and drawings are accordingly to be regarded in an illustrative rather than restrictive sense.

We claim:

1. A travel assistance system, comprising:
at least one processor, the at least one processor comprising:
a service provider interface module configured to communicate with a service provider to request and receive trip-related data and travel event data;
a service provider configuration preference database module configured to store information related to at least one configuration and at least one preference parameter associated with the service provider;
an event collection interface module configured to receive and retrieve event information from at least one information provider;
a traveler interface module configured to transmit and receive traveler data associated with a traveler, wherein the traveler data includes location tracking data;
a traveler configuration and preference database module configured to store at least one configuration data and at least one preference data associated with the traveler;
a general communication interface module configured to transmit and receive information from an external entity;
an event analysis and correlation module configured to receive, analyze, and process information received from the service provider interface module, event collection interface module, traveler interface module, and general communication module, to provide updated trip-related data; and
a transaction gateway module configured to ensure that all trip-related data and updated trip-related data complies with the at least one configuration and at least one preference parameter stored in the service provider configuration preference database and the at least one configuration data and the at least one preference data stored in the traveler configuration and preference database module.

2. The travel assistance system of claim 1, wherein the at least one processor further comprises a travel tracking database module configured to store the trip-related data and the updated trip-related data.

3. The travel assistance system of claim 1, wherein the at least one processor further comprises a controller module configured to manage communication between all modules.

4. The travel assistance system of claim 1, wherein the at least one processor further comprises a support services module configured to support applications and data transmission services provided by the processor modules.

5. The travel assistance system of claim 1, wherein the travel event data includes at least one of a cancellation event, a delay event, a timing change event or a location tracking event.

6. The travel assistance system of claim 1, wherein the event information from the at least one information provider includes at least one of a traffic-related event, a weather-related event, or a national disaster event.

7. The travel assistance system of claim 2, wherein the event analysis and correlation module is further configured to:
identify at least one segment associated with the travel plan impacted by the event information from the at least one information provider or the travel related event data;
instruct the service provider interface module to query at least one travel provider for alternative travel segments that may replace the at least one impacted travel segment;
transmit the best option to the transaction gateway module to confirm that determine that the best option complies with traveler configuration data and preference data;
receive an authorization status from the transaction gateway module;
transmit a reservation request for the best option to the service provider interface module;
receive a reservation confirmation for the best option; and
transmit the reservation confirmation to the travel tracking database module for storage.

8. The travel assistance system of claim 7, wherein the alternative travel segments may include unsolicited offers received by the service provider interface module.

9. The travel assistance system of claim 1, wherein the service provider interface module is configured to only communicate with a service providers that have registered with the travel assistance system.

10. The travel assistance system of claim 1, wherein the traveler interface module configured to receive location tracking data associated with the traveler and wherein the event analysis and correlation module is configured to compare expected location data with received location tracking data to determine a location tracking event that may impact a travel segment.

11. A travel assistance method, comprising:
receiving, via a service provider interface module housed on at least one processor, trip-related data and travel event data;
receiving, via a service provider configuration preference database module, information related to at least one configuration and at least one preference parameter associated with the service provider;
receiving, via an event collection interface module, event information from at least one information provider;
receiving, via a traveler interface module, traveler data associated with a traveler, wherein the traveler data includes location tracking data;
receiving, via a traveler configuration and preference database module, at least one configuration data and at least one preference data associated with the traveler; and
processing, via an event analysis and correlation module configured the information received from the service provider interface module, event collection interface module, and traveler interface module, to provide updated trip-related data, wherein the event analysis correlation module consults a transaction gateway module configured to ensure that all trip-related data and updated trip-related data complies with the at least one configuration and at least one preference parameter stored in the service provider configuration preference database and the at least one configuration data and the at least one preference data stored in the traveler configuration and preference database module.

12. The method of claim 11, further comprising storing, via a travel tracking database module, the trip-related data and the updated trip-related data.

13. The method of claim 11, further comprising transmitting, via a general communication interface module, the updated trip-related data to an external entity.

14. The method of claim 13, wherein the external entity is defined by the traveler and stored in the traveler configuration and preference database module.

15. The method of claim 11, wherein the travel event data includes at least one of a cancellation event, a delay event, a timing change event or a location tracking event.

16. The method of claim 11, wherein the event information from the at least one information provider includes at least one of a traffic-related event, a weather-related event, or a national disaster event.

17. The method of claim 12, further comprising:
identifying at least one segment associated with the travel plan impacted by the event information from the at least one information provider or the travel related event data;
instructing the service provider interface module to query at least one travel provider for alternative travel segments that may replace the at least one impacted travel segment;
transmitting the best option to the transaction gateway module to confirm that determine that the best option complies with traveler configuration data and preference data;
receiving an authorization status from the transaction gateway module;
transmitting a reservation request for the best option to the service provider interface module;
receiving a reservation confirmation for the best option; and
transmitting the reservation confirmation to the travel tracking database module for storage.

18. The method of claim 17, further comprising, before transmitting the best option, determining, via the event analysis and correlation module, relevant alternative travel segments, and analyzing only the relevant alternative travel segments to determine the best option.

19. The method of claim 11, wherein the service provider interface module is configured to only communicate with a service providers that have registered with the travel assistance system.

20. The method of claim 11, further comprising:
receiving, via the traveler interface module, location tracking data associated with the traveler; and
comparing, via the event analysis and correlation module, an expected location data with the received location tracking data to determine a location tracking event that may impact a travel segment.

21. The method of claim 11, wherein the event analysis and correlation module instructs the service provider interface module, event collection interface module, and traveler interface module, to limit the transmitted information according to at least one identified filter rule.
